(19) United States
(12) Patent Application Publication
(10) Pub. No.: US 2001/0007676 A1
(43) Pub. Date: Jul. 12, 2001

(54) Transparent clear suspension nail polish enamel

(76) Inventors: Ronnie F. Mui, Reading, PA (US); Michelle E. Pepe, South Plainfield, NJ (US); Thomas R. Candia, Cedar Grove, NJ (US); Eric P. Wimmer, Princeton, NJ (US)

Correspondence Address: DANN DORFMAN HERRELL & SKILLMAN, SUITE 720, 1601 MARKET STREET, PHILADELPHIA, PA, 19103-2307, US

(21) Appl. No.: 09/734,819

(22) Filed: Dec. 12, 2000

Related U.S. Application Data
(63) Continuation-in-part of application No. 09/455,306, filed on Dec. 6, 1999.

(51) Int. Cl. C09D 1/00; C09K 3/00; C09D 4/00; C09D 5/00; C09D 11/00

(52) U.S. Cl. 424/401; 106/31.03

(57) ABSTRACT

Clear and translucent nail polish compositions comprise stabilized colorant systems contained therein whereby pigments, dyes, glitter, mica and pearls are uniformly dispersed throughout the nail polish. The nail polish is clear and not opaque nor do the colorants settle during storage over time. The system is made possible using a silica-based suspension agent consisting of fumed silica in a traditional nail polish base further comprising one or more solvents, film-forming agents, resins, plasticizers and the like. Preferably, micas, glitter, pearls and/or ornamental sparkles are uniformly dispersed throughout the clear to translucent polish and are visible therein.

### FIELD OF THE INVENTION

The present invention relates generally to the area of cosmetics and cosmetic formulations for external use on the body. More particularly, the present invention relates to novel, clear suspension of and translucent nail polish compositions.

### BACKGROUND OF THE INVENTION

Cosmetics and their use as decorative applications for the human body have been in existence for centuries and are used extensively throughout the world. A multi-billion dollar industry, cosmetics perform many different functions from lipstick to eyeliner, facial creams, powders, highlighters and nail polishes or lacquers. Although they are used primarily by women, their use is extraordinary and has made many of the cosmetic producing and marketing firms very profitable endeavors.

The nail polish sector of the cosmetic industry is extremely competitive and new colors, combinations and variations thereof are constantly being introduced in an attempt by the formulator to get and hold onto a bigger piece of the market share. The scientific research that is poured into these endeavors is considerable and new products and/or brand names are continually being introduced.

Nail polishes are essentially comprised of pigments and/or dyes that are incorporated and suspended in various solvents and bases. They must also be stabilized in suspension since if during the shelf life of the product the pigments should float, settle, separate or striate, the products appearance will be adversely affected. Nail polishes should also be formulated so that the film formed thereby is tough and durable and adheres to the human nail and will not readily crack, chip, peel or splinter when worn. This toughness should last for an extended time as well so that the polish enamel is durable.

Nail enamels conventionally comprise a film forming component, which is frequently nitrocellulose, cellulose acetate butyrate, or a combination of one or both of those cellulosics with a polyurethane or other polymeric compound. Nail enamels have also traditionally included plasticizers, typically a phthalate such as dibutyl phthalate, or camphor, and have also typically included as an adhesion promoter, a polymeric component formed by the condensation polymerization of formaldehyde or other aldehyde, typically an aromatic sulfonamide-aldehyde condensation resin, or a polyester resin such as phthalic anhydride, trimellitic anhydride, glycol copolymers and mixtures thereof.

Nail polish and nail enamels are generally prepared by incorporating a desired colored pigment in the above described mixtures and it is these pigments that give the nail polish its color. Pigments consist of mineral fillers such as aluminum oxide, barium sulfate, calcium sulfate and mixtures thereof which have been precipitated with a dye such as any one of a number of FD&C dyes approved for use in cosmetic applications. These include various aromatic types such as azo, indigoid, triphenylmethane, anthraquinone, hydroquinones and xanthine dyes, also referred to as the D&C and FD&C colors. These colors are set forth on page 21 of the CFTA Cosmetic Ingredient Handbook, First Edition, 1988, which is hereby incorporated by reference. Also included within this definition are the lakes of the D&C and FD&C colors, which consist generally of an insoluble metallic salt of a D&C and FD&C color deposited on an inert substrate such as alumina. The lakes are set forth on page 22 of the CFTA Cosmetic Ingredient Handbook, First Edition, 1988 which is also incorporated by reference herein. Dyes can also be incorporated directly into the nail polish composition without the mineral filler base but this results in a somewhat translucent, faded-looking composition. Pigments on the other hand present an opaque but vibrant color which, when dried onto the nail itself can give a glossy shear or flat matte appearance. Nail polishes can also glitter and give a sparkling appearance through the incorporation of micas, pearls, glitters and other small ornamental sparkles which are dispersed in the medium and add another dimension to the nail polish or enamels aesthetic appearance.

However, pigments, micas and the like are highly dense and without more, will settle to the bottom of the nail polish system resulting in an unacceptable product. This might be rectified by shaking of the bottle just before use but the product would have to be applied to the nail immediately, and even then shaking does not guarantee the pigment and/or micas will be uniformly dispersed throughout the nail polish and streaky or blotchy coated nails may result.

To overcome this problem, the cosmetics industry has traditionally utilized a suspension agent in the nail polish to keep the pigments, micas, glitter etc. uniformly distributed throughout the nail polish composition. The suspension agents prevent the settling of these pigment and dye components and allows for the preparation of a nail polish, enamel or lacquer that is opaque and uniform in color. The suspension agents not only suspend the pigments in the solvent but also adjust the viscosity of the nail polish or enamel to achieve the desired flowability.

Traditionally, the suspension agents used for this purpose were organo-modified montmorillonite clays such as stearalkonium hectorite and stearalkonium bentonite. These clays however, when formulated as a gel and then dissolved in the solvent render the nail polish enamel base yellowish in color and opaque in appearance. When pigment or dye is subsequently added to this, brilliant colors are obtainable but a clear or translucent nail polish or nail enamel is not.

Prior attempts to prepare a clear or translucent nail polish or enamel without these suspension agents have resulted in a product with one or more deficiencies. As discussed supra, without a suspension aid the pigment particles will slowly sink and settle on the bottom of the nail polish bottle resulting in a colorless system. Pigments also “migrate” forming striations, marbleization and/or layered effects leading to a non-uniform appearance. The pigments can also separate out of the solvent forming a clear liquid layer that floats at the top of the nail polish bottle.

U.S. Pat. No. 5,133,966 to Khamis discloses nail polish formulations comprising improved pigment suspension systems. More specifically, the suspensions comprise carboxylic acids and their salts with a resin carrier in a buffered coating process that allegedly yields a hydrophobic coating with increased dispersion characteristics. Surprisingly, these suspensions allegedly do not effect the uniform dispersion of the pigments or the gloss and color of the nail polish enamel.

U.S. Pat. No. 5,174,996 to Weber et al. discloses nail enamels with improved floatation, migration and settlement characteristics. These improved features are achieved by coating the pigments with oxidized polyethylene. The nail polish or enamel still requires the incorporation of stearalkonium hectorite to uniformly suspend the pigment in the system.

U.S. Pat. No. 4,649,045 to Goshi discloses nail enamel and polish compositions comprising a pigment concentrate in which the colored pigments are dispersed in a copolymer film consisting of at least one aromatic monoethylenic monomer and one monoethylenic ester prior to incorporation in the solvent. The pigment concentrate is asserted to remain stable and uniformly dispersed with no flocculation, separation or settling after storage for long periods of time. However, thickening agents such as quaternized montmorillonite clays (hectorites) and quaternized amine-modified kaolin clays are added to the nail polish composition and these also function as suspension agents.

It has been surprisingly and unexpectedly discovered however, that a clear nail polish base is achievable that still maintains any colored pigment, pearls, mica, glitters and the like in suspension indefinitely with no separation or settling. This is achieved without the use of the traditional suspension agents, stearalkonium hectorite, stearalkonium bentonite or the quaternized amino-modified kaolin clays. This also permits preparation of a clear nail polish that has visual depth through the uniform dispersion of pigment and other agents that add sparkle and shapes such as mica, glitter, stars, pearls and ornamental sparkles.

### SUMMARY OF THE INVENTION

Clear to translucent nail polish and enamel is achieved through the elimination of traditional suspension agents such as stearalkonium hectorite and stearalkonium bentonite which otherwise opacify and cloud the nail polish base. A colorant or light reflectant such as pigments, dyes, glitter, pearls, and mica and ornamental sparkles remain uniformly dispersed in the nail polish even during long periods of storage through the use of fumed silica as the suspension agent.

### DETAILED DESCRIPTION OF THE INVENTION

The clear nail polish and nail enamel compositions of the present invention comprise many of the traditional ingredients known in the art. These include a solvent, film forming agents, plasticizers, adhesion promoters and colorant such as pigments, dyes and the like. The solvent components are selected to be as inert to the user's nail and to the other components of the nail enamel composition as possible. It should also be capable of dissolving or dispersing the other components so that they readily flow onto the nail. The solvent must be able to evaporate from the nail in a matter of minutes at room temperature and pressure so that the film forming agents, plasticizers and other components dissolved therein solidify and adhere to the nail surface. The solvents have traditionally been volatile, aromatic-containing solvents in order to achieve the best results. These include xylene, toluene and mixtures thereof. However, it has also been found that the nail polish and nail enamel compositions of the present invention can also be prepared using solvents that are free of aromatic-containing compounds. Examples of preferred non-aromatic solvents include isopropanol, butyl acetate, ethyl acetate, methyl ethyl ketone, propyl acetate, diacetone alcohol and mixtures thereof. These less volatile compounds enable the preparation of a more stable, non-toxic nail enamel composition.

The remaining ingredients in the novel nail enamel formulations of the present invention include those compounds well known in the nail polish industry. A film forming agent is necessary in order to provide the nail enamel with a consistency that results in the formulation of a uniform, stable film on the surface of the nail when the enamel is applied thereon. Nitrocellulose is the preferred film former and must be incorporated in the formulation in amounts that will cause the enamel to readily spread out about the surface of the nail yet remain viscous enough to not run or drip therefrom. However, it must also readily cling to and flow from the applicator brush as the enamel is applied from the bottle to nail and this generally comprises from about 5.0 to 40 wt. % of the total weight of the composition and preferably will be incorporated in amounts of from about 3.0 to about 30 wt. %. Other suitable, but not preferred film-formers include acrylate copolymers, cellulose acetate butyrate, polyurethanes, and mixtures thereof.

A third component in the system is the adhesion promoter which doubly functions as a gloss enhancer. These compounds are generally polyester resins selected from the group consisting of phthalic anhydride/trimellitic anhydride/glycols copolymers. These are generally incorporated in the nail polish compositions in an amount of from about 5.0 wt. % to 12.0 wt. % and preferably about 8.0 wt. %.

Whereas nitrocellulose is the preferred film forming agent of the present invention and is used most commonly throughout the nail polish and enamel industries, the tensile strength and the adhesive qualitites of the enamel for the nail surface are generally inferior if nitrocellulose is used alone as the sole film-forming agent. The addition of one or more plasticizers greatly improves the nail polish in this regard. Dibutyl phthalate has been an often used plasticizer for this purpose as it provides excellent flexibility, elongation and tensile strength to nail polish formulations. Other suitable plasticizers include the adipates, pentaerythrityl tetrabenzoate, 2,2,4-trimethyl-1,3-pentanediol diisobutyrate and mixtures thereof. More specifically, suitable adipates include dioctyl adipate, diisobutyl adipate, diisostearyl adipate, diisostearyl adipate, diisocetyl adipate, diisodecyl adipate, diisononyl adipate and mixtures thereof. The use and incorporation of these plasticizers is more fully set forth in U.S. Pat. No. 5,882,636 to Mui et al. which is hereby incorporated by reference.

The nail enamel compositions of the present invention can be clear, i.e. unpigmented, or they can include a colorant such as a pigment component, dyes, mica, glitter or pearls as are known in the art. Suitable pigments include the inorganic and organic pigments which are useable in cosmetic formulations. Particular examples include titanium dioxide, D&C Red #6 Barium Lake, D&C Red #7 Calcium Lake, D&C Red #34 Calcium Lake, FD&C Yellow #Aluminum Lake, Ferric Ferrocyanide, Red Iron Oxide, Black Iron Oxide, Mica, Bismuth Oxychloride, Guanine, D&C Red #17, D&C Red #33, D&C Violet #2, D&C Yellow #11, FD&C Blue #1 and FD&C Green #3. Preferably, due to the clear to translucent nature of the nail enamel compositions of the present invention, micas, glitters, ornamental sparkles and pearls are employed which are more visibly dazzling.

The term “pigment” includes mixtures of one or more of the foregoing compounds. These pigments can be surface treated for even better performance. See U.S. Pat. Nos. 5,133,966 to Khamis; 4,832,944 to Socci et al. and 5,174,966 to Weber et al., all of which are also hereby incorporated herein by reference.

The amounts of any particular ingredients comprising the pigment component will of course, depend on the shade desired by the practitioner. In general, the pigment component comprises from about 0.01 to about 15.0 wt. % based on the total weight of the composition.

The silica suspending agent of the present invention that allows for the preparation of a clear to translucent nail polish or enamel may be any one of a number of silica compounds known in the art. These include amorphous silica, amorphous silicon oxide hydrate, silica anhydride, silicon dioxide, fumed silica, fumed silicon dioxide, silica hydrate, silicic acid and mixtures thereof.

Preferably, the suspension agent of choice is fumed silica which exists in hydrophilic, hydrophobic and as a mixture or blend of hydrophilic and hydrophobic fumed silicas. Fumed silica is a highly dispersed amorphous silica that is derived through flame hydrolysis of silicon tetrachloride. Fumed silica consists of a mass of spherical particles which have an average diameter between 7 nm to 40 nm. When smaller primary particles are present, dispersion is naturally more difficult as a result of the greater aggregation and agglomeration.

Fumed silica is a well known thickener and has proved useful in a wide variety of systems to control and improve the rheology thereof. Fumed silica functions as a thickener due to the presence of the surface silanol groups (Si—OH) which are capable of hydrogen bonding to adjacent silica particles. When properly dispersed, the hydrogen bonds between adjacent particles form a stable three-dimensional thickening network. This network is structured such that it can suspend pigments, pearls, micas, and polyethylene terephthalates (glitters), preventing them from settling while assuring a homogenous distribution throughout the formulation. This also applies to the silicas that contain siloxane groups (Si—O—Si), which are non-polar, non-reactive, and hydrophobic. All synthetic silicas which have not been post-treated are hydrophilic, due to the silanol groups present on the particles' surface. By replacing these silanol groups with methyl groups they become hydrophobic.

In order to achieve maximum thickening and long term viscosity stability using the filmed silicas, high speed dispersion mixers are used to first prepare a silica gel which is then diluted to make a clear suspension. The gel is prepared by first mixing the film forming agent, plasticizer and solvent at moderate speed in a high speed blender. The fumed silica is slowly added to this mix at a slow speed which is then increased to high speed until the gel turns color from an opaque white to a clear gel.

In a second container, a dilution solution is prepared so that the nail polish attains the proper viscosity and flow properties. This is comprised of additional plasticizer, solvent, film forming agents and color pigments. The plasticizers are first pre-mixed in the solvent which is mixed for about ten (10) minutes. A polymeric film forming solution consisting of one or more polymers is then added. Suitable polymers are selected from the group comprising nitrocellulose, acrylate copolymers, styrene acrylate copolymers, sucrose acetate isobutyrate polyurethane/urethane copolymers, cellulose acetate butyrate, polyvinyl acetate polymers, epoxy resin polymers and mixtures thereof. This is mixed and additional film former is added. An alcohol/dye solution is pre-mixed prior to adding the pigment to the mix. Both mixes are then combined and further mixed resulting in a glossy clear suspension nail enamel.

The following examples are provided to more specifically define the formulations of the present invention and to disclose preferred embodiments of the nail enamels. They are presented for illustrative purposes only and it is recognized that there are minor changes and alterations that can be made with respect to the ingredients and/or their amounts not disclosed herein. It should be understood that to the extent any such changes do not materially affect the final composition or its functionality, they are considered to fall within the spirit and scope of the invention as later recited in the claims.

### EXAMPLE 1

An aromatic free glossy clear suspension nail enamel was prepared as follows. In a first mixing bowl, the following ingredients were combined in their respective amounts as follow:

| | | Weight |
|---|---|---|
| Component | | Percent (wt. %) |
| A. | Resin | |
| | Phthalic Anhydride/ | 9.891% |
| | Trimellitic | |
| | Anhydride/Glycols Copolymer | |
| | Sucrose Acetate | 3.956% |
| | Isobutyrate | |
| B. | Film Forming Agents | |
| | Nitrocellulose | 13.055% |

These components A and B were mixed at moderate speed for five (5) minutes. To this mixture the following was added.

| C. | Plasticizer | |
|---|---|---|
| | Dioctyl Adipate | 0.593% |

This was also mixed in at moderate speed for five (5) minutes.

| D. | Solvent | |
|---|---|---|
| | Butyl Alcohol | 0.593% |
| | Benzyl Alcohol | 0.593% |

This was also mixed at moderate speed for five (5) minutes.

| E. | Suspension Agent | |
|---|---|---|
| | Fumed Silica | 2.769% |

This was added at low speed. The blender was then adjusted to 2000 r.p.m. for thirty (30) minutes until the solution changed from an opaque white color to a clear gel. A second pre-mix was prepared as a dilution solution comprising more of the above without the fumed silica.

| F. | Resin | |
|---|---|---|
| | Phthalic Anydride/ | 3.956% |
| | Trimellitic | |
| | Anhydride/Glycols Copolymer | |
| G. | Solvent | |
| | Ethyl Acetate | 1.681% |
| | Butyl Acetate | 1.681% |

These were mixed at moderate speed for five (5) minutes.

| H. | Polymeric Solution | |
|---|---|---|
| | Styrene Acrylate Copolymer | 23.216% |

This was also mixed in at moderate speed for ten (10) minutes.

| | | |
|---|---|---|
| I. | Film Forming Agent | |
| | Nitrocellulose | 20.061% |
| J. | Secondary Solvent | |
| | Denatured Alcohol | 6.107% |
| | Ester Solvent | 9.871% |
| K. | Colorants/Pigments/ | As desired |
| | Glitter/Micas | |

The two pre-mixes were combined and blended together for one-half (½) to one (1) hour to insure a uniformly dispersed composition. A clear, see through nail polish was obtained with specks of colored mica dispersed throughout. The dispersed mica remained uniformly dispersed and does not sink or settle.

### EXAMPLE 2

A matte clear suspension nail enamel was prepared using the same pre-mix procedure as in Example 1 using the following compounds.

| | Weight |
|---|---|
| Component | Percent (wt. %) |
| Heptane | 21.690% |
| Xylene | 19.690% |
| Ethyl Acetate | 19.220% |
| Isopropyl Alcohol | 11.120% |
| Nitrocellulose | 9.350% |
| Butyl Acetate | 6.730% |
| Tosylamide/Epoxy Resin | 4.260% |
| Silica | 3.130% |
| Dibutyl Phthalate | 2.970% |
| Camphor | 0.960% |
| Butyl Alcohol | 0.880% |

### EXAMPLE 3

A glossy clear suspension nail enamel was prepared without any pigment or suspended particles as a clear lacquer. The following components were mixed together in their respective amounts following the procedure of Examples 1 and 2.

| | Weight |
|---|---|
| Component | Percent (wt. %) |
| Ethyl Acetate | 23.720% |
| Butyl Acetate | 18.570% |
| Xylene | 17.950% |
| Nitrocellulose | 13.590% |
| Phthalic Anhydride/ | 9.750% |
| Trimellitic | |
| Anhydride/Glycols Copolymer | |
| Isopropyl Alcohol | 7.710% |
| Sucrose Acetate Isobutyrate | 3.240% |
| Fumed Silica | 2.650% |
| Benzyl Alcohol | 1.250% |
| Butyl Alcohol | 1.000% |
| Dioctyl Adipate | 0.570% |

What is claimed is:

1. A clear nail enamel suspension with a pigment-free light reflectant uniformly dispersed therein that will not settle during storage consisting of fumed silica, one or more solvents, one or more film forming agents, one or more resins, one or more plasticizers and mixtures thereof.

2. The clear nail enamel suspension of claim 1 wherein said plasticizer is selected from the group consisting of dibutyl phthalate, pentaerythrityl tetrabenzoate, dioctyl adipate, diisobutyl adipate, diisodecyl adipate, diisononyl adipate and mixtures thereof.

3. The clear nail enamel suspension of claim 1 wherein said film forming agent is selected from the group consisting of nitrocellulose, acrylate copolymers, cellulose acetate butyrate, polyurethanes and mixtures thereof.

4. The clear nail enamel suspension of claim 1 wherein said resin is selected from the group consisting of phthalic anhydride/trimellitic anhydride/glycols copolymers sucrose acetate isobutyrate, tosylamide/epoxy resin, styrene acrylate copolymer and mixtures thereof.

5. The clear nail enamel suspension of claim 1 wherein said solvent is selected from the group consisting of isopropanol, butyl acetate, ethyl acetate, methyl ethyl ketone, propyl acetate, diacetone alcohol and mixtures thereof.

6. The clear nail enamel suspension of claim 1 wherein the light reflectant is selected from the group consisting of dye, glitter, pearls, stars, mica, ornamental sparkles and mixtures thereof.

7. The clear nail enamel suspension of claim 6 wherein the light reflectant is selected from the group consisting of glitter, dyes, ornamental sparkles and mixtures thereof.

8. A method for the uniform suspension of a light reflectant in a clear nail enamel composition comprising one or more solvents, a film-forming agent, one or more plasticizers, one or more resins, a light reflectant and mixtures thereof, said method comprising the step of incorporating in said composition fumed silica.

9. The method of claim 8 wherein said plasticizer is selected from the group consisting of dibutyl phthalate, pentaerythrityl tetrabenzoate, dioctyl adipate, diisobutyl adipate, diisodecyl adipate, diisononyl adipate and mixtures thereof.

10. The method of claim 9 wherein said film-forming agent is selected from the group consisting of nitrocellulose, acrylate copolymers, cellulose acetate butyrate, polyurethanes and mixtures thereof.

11. The method of claim 10 wherein said resin is selected from the group consisting of phthalic anhydride/trimellitic anhydride/glycols copolymers, sucrose acetate isobutyrate, styrene acrylate copolymer, tosylamide/epoxy resin and mixtures thereof.

12. The method of claim 11 wherein said solvent is selected from the group consisting of isopropanol, butyl acetate, ethyl acetate, methyl ethyl ketone, propyl acetate, diacetone alcohol and mixtures thereof.

13. The method of claim 7 wherein the light reflectant is selected from the group consisting of dye, glitter, pearls, stars, mica, ornamental sparkles and mixtures thereof.

14. The method of claim 13 wherein the light reflectant is selected from the group consisting of dye, glitter, ornamental sparkles and mixtures thereof.

15. A pigment-free clear nail enamel composition comprising one or more solvents, one or more film-forming agents, one or more resins, one or more plasticizers, light reflectant and a silica-based suspension agent wherein the light reflectant remains dispersed throughout the composition after prolonged periods of storage.

16. The composition of claim 15 wherein said plasticizer is selected from the group consisting of dibutyl phthalate, pentaerythrityl tetrabenzoate, dioctyl adipate, diisobutyl adipate, diisodecyl adipate, diisononyl adipate and mixtures thereof.

17. The composition of claim 15 wherein said film-forming agent is selected from the group consisting of nitrocellulose, acrylate copolymers, cellulose acetate butyrate, polyurethanes and mixtures thereof.

18. The composition of claim 15 wherein said resin is selected from the group consisting of phthalic anhydride/trimellitic anhydride/glycols copolymers, sucrose acetate isobutyrate, styrene acrylate copolymer, tosylamide/epoxy resin and mixtures thereof.

19. The composition of claim 15 wherein said solvent is selected from the group consisting of isopropanol, butyl acetate, ethyl acetate, methyl ethyl ketone, propyl acetate, diacetone alcohol and mixtures thereof.

20. A method of preparing a thickening and stabilizing suspension for a nail polish enamel, said method comprising the steps of:
a. mixing a film-forming agent, plasticizer and solvent at a moderate speed to form a mixture;
b. adding to the mixture a fumed silica to form a gel; and
c. mixing the gel at increased mixing speed until the gel turns from opaque to clear.

21. A method of preparing a nail polish enamel comprising a mixture of a thickening and stabilizing composition and a dilution solution wherein the thickening and stabilizing composition is prepared by the steps of:
a. mixing a film-forming agent, plasticizer and solvent at moderate speed to form a mixture;
b. adding to the mixture a fumed silica to form a gel; and
c. mixing the gel at increased mixing speed until the gel turns from opaque to clear and the dilution solution is prepared by mixing plasticizer, solvent and at least one polymeric film-former to form the dilution solution.

22. A method according to claim 21 including the additional step of adding a light reflectant to the mixture of the thickening and stabilizing solution and the dilution solution.

23. A method according to claim 22 wherein the light reflectant is selected from the group consisting of dye, glitter, pearls, stars, mica, ornamental sparkles and mixtures thereof.

24. A method according to claim 22 wherein the light reflectant is selected from the group consisting of dye, glitter ornamental sparkles and mixtures thereof.

25. A pigment-free, and nail enamel suspension comprising a film forming agent, plasticizer, adhesion promoter, light reflectant and non-aromatic solvent.

26. The pigment-free, nail enamel suspension of claim 25 wherein the non-aromatic solvent is selected from the group consisting of isopropanol, butyl acetate, ethyl acetate, methyl ethyl ketone, propyl acetate, diacetone alcohol and mixtures thereof.

27. The pigment-free, nail enamel suspension of claim 26 wherein the non-aromatic solvent is a mixture of isopropanol, butyl acetate and ethyl acetate.

28. The pigment-free, nail enamel suspension of claim 25 wherein the light reflectant is selected from the group consisting of glitter, dye, pearls, stars, mica, ornamental sparkles and mixtures thereof.

29. The pigment-free, nail enamel suspension of claim 28 wherein the light reflectant is selected from the group consisting of glitter, dye, ornamental sparkles and mixtures thereof.
